(19) United States
(12) Patent Application Publication
(10) Pub. No.: US 2015/0261837 A1
(43) Pub. Date: Sep. 17, 2015

(54) Querying Structured And Unstructured Databases

(71) Applicant: Vinay Avasthi, Bangalore (IN)

(72) Inventor: Vinay Avasthi, Bangalore (IN)

(21) Appl. No.: 14/424,193

(22) PCT Filed: Aug. 29, 2012
(86) PCT No.: PCT/IN2012/000572

§ 371 Date: Feb. 26, 2015

(51) Int. Cl. G06F 17/30

(52) U.S. Cl. CPC G06F 17/30563; G06F 17/30867; G06F 17/30554

(57) ABSTRACT

Provided is a method of querying structured and unstructured databases. A structured database and an unstructured database are queried in conjunction in response to a query. Querying the unstructured database comprises: identifying primary keys from the query, identifying relationships between the primary keys, and querying the unstructured database based on the relationships between the primary keys.

### BACKGROUND

Enterprises typically store their data in two forms: structured and unstructured. Structured data, which may include sales data, employee details, customer information, etc., is stored in a computerized database management system (DBMS). Unstructured data, which could include emails, company reports, training manuals, white papers, web pages, etc., may be stored in different data repositories. Generally, databases containing structured and unstructured data are maintained separately in organizations,

### BRIEF DESCRIPTION OF THE DRAWINGS

For a better understanding of the solution, embodiments will now be described, purely by way of example, with reference to the accompanying drawings, in which:

FIG. 1 is a schematic block diagram of a system according to an example.

FIG. 2 is a schematic block diagram of unstructured data processing module of FIG. 1, according to an example.

FIG. 3 shows a flow chart of a method of querying a structured and an unstructured database, according to an example.

FIG. 4 shows a flow chart of a sub-routine of the method of FIG. 3, according to an example.

FIG. 5 is a schematic block diagram of an unstructured data processing module hosted on a computer system, according to an example.

### DETAILED DESCRIPTION OF THE INVENTION

Depending on the nature of a business, its size and scale, organizations may handle a large amount of data. Some of this data may undergo an ETL (extract, load and transform) process for storage in a computerized data base management system (DBMS). The resultant data (in the database) forms the structured data. In addition, there may he data in an organization which does not have a pre-defined data model and/or does not fit well into relational tables (like structured data). This form of data is termed as unstructured data. For the sake of clarity, the following definitions may be used herein.

“Structured data” refers to data that is organized in a structure. It has an enforced composition against a predetermined data type(s), which may allow for querying and reporting against these data types. Relational databases and spreadsheets are examples of structured data.

“Unstructured data” refers to data that is not “structured data”. The term includes any data stored in an unstructured format. Unstructured data has no identifiable structure and there is no conceptual data or data type. Examples may include ernails, images, audio tiles, videos, etc. in their original format.

In an example, an unstructured data can be converted into a structured data through an ETL (extract, load and transform) process for storage in a computerized data base management system (DBMS) of an enterprise. ETL is a process that involves extracting data from data sources, transforming it to fit operational needs and loading it into an end target (for example, a database). One of the issues with the process of converting an unstructured data into structured data (for instance through an ETL process) is that a significant amount of information that exists in the unstructured data may get lost during the conversion process. For example, let's assume that a report on the population of a country contains details like yearly population data, number of males, number of females, number of children below the age of ten, number of people above the age of sixty, etc., for the last fifty years. Now let's consider that the aforesaid details are to be captured in a structured database table that only has fields for capturing the data for every decade and, in addition, have no fields to capture data related to the number of people above the age of sixty. One could easily envisage that such conversion of data could result in a loss of a significant amount of information which could be valuable to an enterprise. For example, at a later date, or as part of some unrelated computation, if a user needs data on yearly population, the same will not be available because it wasn't captured during the transformation even though the unstructured data contained the required information. Similar problem would be faced with regards to non-availability of data on number of people above the age of sixty.

It is not difficult to realize that the aforementioned scenarios are not ideal from the perspective of an enterprise which may end up losing potentially valuable information even though it was available in an unstructured format.

Proposed is a solution that allows querying of a structured and an unstructured database in conjunction. In an example, the results obtained from querying of both databases (structured and unstructured) are combined prior to display to a user.

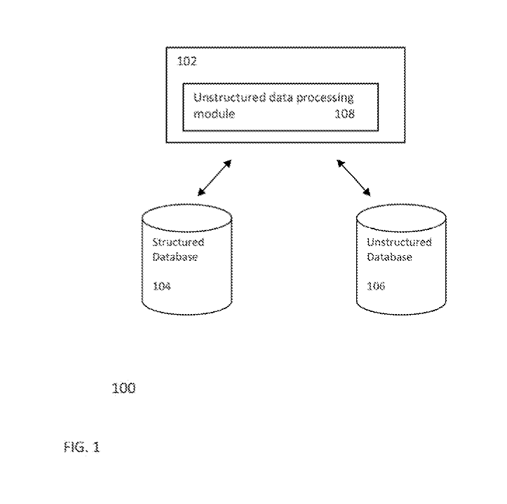

FIG. 1 is a schematic block diagram of a system according to an example. System 100 includes user computer system 102, structured database 104, and unstructured database 106, Computer system 102 may be connected to structured database 104 and unstructured database 106 through a network, which may be wired or wireless. The network may be a public network such as the Internet, or a private network such as an intranet. In some implementations, system 100 may include additional user computer systems, structured databases and unstructured databases than illustrated in FIG. 1.

User computer system 102 may be a computer server, desktop computer, notebook computer, tablet computer, mobile phone, personal digital assistant (PDA), or the like. User computer system 102 may include an interface for obtaining a query (queries). The aforesaid interface may be a graphical user interface (GUI). Further, a query may be system defined or obtained from a user. In an example, the query is a structured query language (SQL) query. User computer system 102 may also include an unstructured data processing module 108. Unstructured data processing module 108, which is described in detail below, processes an unstructured data based on an input query.

Structured database 104 is a database that holds structured data. For example, data organized within a database management system (DBMS) may constitute a structured database 104. In an example, aforesaid DBMS may be a relational database management system (RDBMS). Structured database 104 may use a variety of database models, such as the relational model, hierarchical, or object model, to describe and store data. Also, structured database 104 may support high level query languages, such as the structured query language (SQL).

Unstructured database 106 is a database that holds unstructured data. Unstructured database 106 may be a repository of unstructured data such as web pages, company manuals, white papers, annual reports, emails, text, images, videos, or other data that is not structured data.

In an implementation, structured database 104 and unstructured database 106 are hosted on different computer systems. In another implementation, however, structured database 104 and unstructured database 106 may be present on a single host computer system. In a yet another implementation, structured database 104 and unstructured database 106 may be present on user computer system 102.

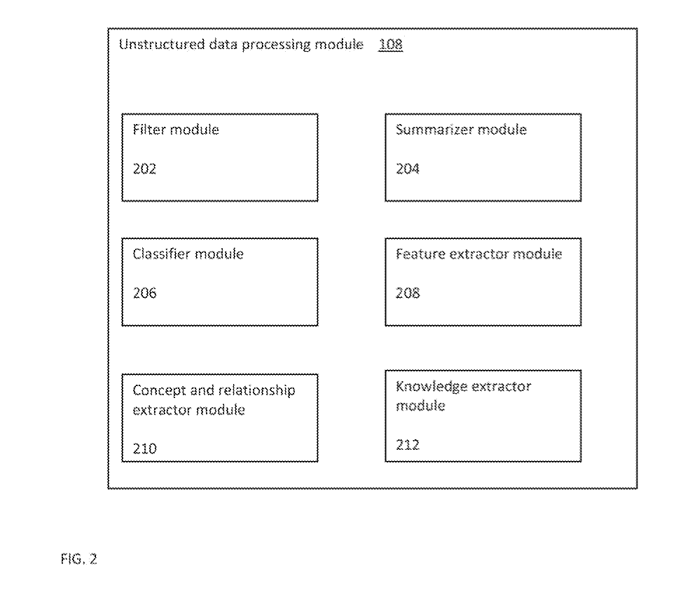

FIG. 2 is a schematic block diagram of unstructured data processing module of FIG. 1, according to an example.

Unstructured data processing module 108 includes filter module 202, summarizer module 204, classifier module 206, feature extractor module 208, concept and relationship extractor module 210, and knowledge extractor module 212.

Filter module 202 allows filtering of unstructured data depending upon the type of filter employed. For example, filter module 202 may apply content specific filtering on unstructured data. In another example, a context specific filter may be used on unstructured data. In an implementation, multiple filter modules 202 may be used to process unstructured data. These filter modules may be arranged in a sequence to obtain a desired result.

Summarizer module 204 is used to summarize unstructured data. Summarizer module 204 may adopt an analytical approach, statistical approach, information retrieval approach etc. or any combination thereof to summarize unstructured data. Summarization may result in a flat summary, structured summary, distributed flat summary, etc. In an example, summarization may result in word count or line count of the unstructured data.

Classifier module 206 automatically classifies unstructured data into different categories based on a predefined set. Classifier module 206 may classify data based on a required model. For example, an object oriented model or entity relationship (ER) model. The classification of the data could be flat or hierarchical, and there many algorithms that could be used for this purpose. Some non-limiting examples of these algorithms may include Page rank algorithm, Bayesian algorithm and concept vector based (CVB) algorithm. Machine learning, probabilistic methods, and indexing may be used by classifier module 206 for classifying unstructured data.

Feature Extraction 208 module analyses unstructured data to recognize and classify vocabulary items in unrestricted natural language texts. The module transforms unstructured documents into small units of text called features or terms. By way of non-limiting examples, following features may be identified and extracted from an unstructured data stream: names, multiword terms, abbreviations, relations, percentages, units, textual numbers etc. In an implementation, after the features are extracted, canonical names are assigned to features thereby easing the process of incorporating this data in future steps.

Concept and relationship extraction module 210 extracts concepts and relationships from unstructured data. Concepts may be extracted using a variety of methods. Some of the non-limiting techniques of concept extraction may include spectral analysis, expectation maximization (EM) technique, Formal Concept Analysis (FCA), Biclustering, Triclustering, Conceptual Graphs etc. Relationship extraction involves identification of relationship between or among concepts. To provide a simple example, PERSON located in LOCATION (extracted from the sentence “Jack is in Germany.”). To provide another example, let's consider the following information in a document: “India's literacy rate rises to 74%: Census. In past 10 years, female literacy rate rose to 65.46% in 2011 from 53.67% in 2001; male literacy rose from 75.26% to 82.14%”. In this example, a number of features, such as, male, female, literacy, census, India, percentage, 10 Years (Decade), etc. can be identified. A concept in this data could be “literacy growth”. And the relationships that could be identified may include: (a) Country, Year, and Literacy; (b) Country, Year, and Male Literacy; and (c) Country, Year, and Female Literacy.

Knowledge Extraction module 212 is used for creation of knowledge from unstructured data. Knowledge Extraction module 212 is used to draw inferences based on the logical content of the input data. The module may employ techniques such as but not limited to Ontology Learning OL), Ontology-Based Information Extraction (OBIE), Traditional Information Extraction (TIE), etc. to extract knowledge from unstructured data. It is used, for example, to identify trends, relations between objects (for instance, people, places, organizations, things, etc.) etc. in the unstructured data. It may also be used to extract metadata.

The aforementioned modules may be arranged in a sequence such that an output from one module may act as an input for another module. Further, the order or arrangement of these modules may vary among different implementations. For example, in one implementation these modules may arranged in the following sequence, such that the output from a preceding module acts as an input for the succeeding module in the series: Filter module 202, Summarizer module 204, Classifier module 206, Feature extractor module 208, Concept and relationship extractor module 210, and Knowledge module 212, In another implementation, the sequence may be as follows: Summarizer module 204, Filter module 202, Feature extractor module 208, Classifier module 206, Concept and relationship extractor module 210, and Knowledge module 212. Likewise there could be other arrangements of these modules. In another implementation, any of the aforesaid modules may be combined together, and their functions may be performed by the combined module.

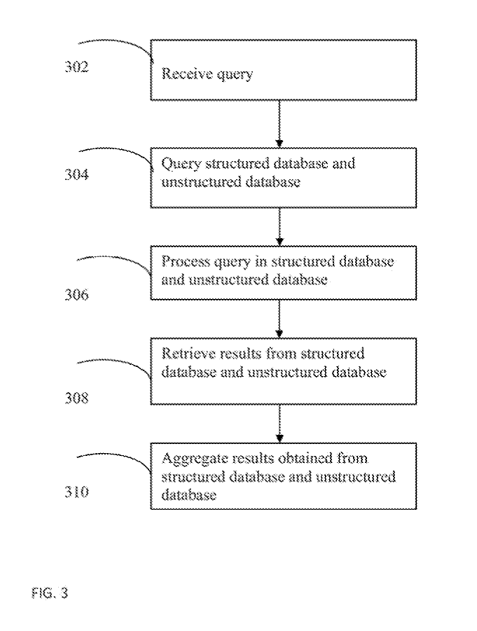

FIG. 3 shows a flow chart of a method of querying a structured and an unstructured database, according to an example.

At block 302, a query is received by a processing unit of a computing device. In an implementation, the query is received from a user of the computing device who may use a graphical user interface to provide the query. In another implementation, the query may be a system generated query which is generated by the computing device itself or by another device coupled to the aforesaid computing device through a network. In an example, the query is a text query. However, in other implementations, other types of queries (such as text with, for instance, an image) may be used. In an implementation, format of a query may be of a type which is understandable by a structured database. For example, it may be a structured query language (SQL) query.

At block 304, a structured database and an unstructured database are queried based on the received query. In an implementation, a structured database and an unstructured database are queried in conjunction. In other words, the query is shared both with a structured database as well as an unstructured database. To provide an illustration, let's assume that the query is “Population, China, 2010”. In this case, the query “Population, China, 2010” would be passed both to a structured database and an unstructured database. In an implementation, a simultaneous querying of a structured and an unstructured database may be carried out. In this case, the query is shared with both types of database in real-time. Further, in some implementations, a plurality of structured databases and/or unstructured databases may be queried based on the received query.

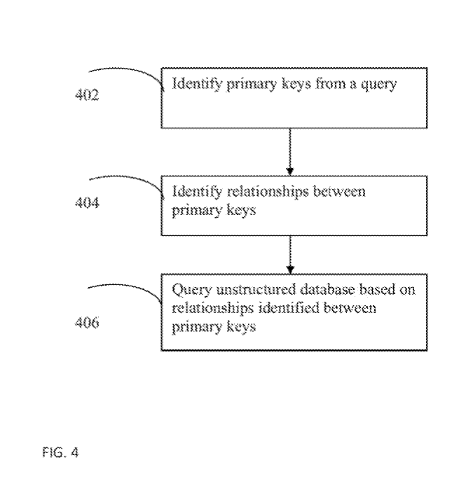

Querying an unstructured database may comprise a number of stages, These are described later in this document with reference to FIG. 4.

At block 306, the query is processed by the structured database and the unstructured database. In case of the unstructured database, processing of the query is performed by unstructured data processing module 108, which may be present on the computing device or another device coupled to the computing device through a network. The processing of a query in unstructured data processing module 108 is described later in this document with reference to FIG. 4.

At block 308, results of the query are retrieved from the structured database as well as the unstructured database. To illustrate in the context of aforementioned query “Population, China, 2010”, the structured database may give a result 1.3 billion, and the unstructured database may provide a more specific result, such as 1.34 billion. It is also possible that the structured database may not provide any results since relevant data may not be available.

At block 310, results of the query obtained from the structured database and the unstructured database are aggregated together. In the context of query “Population, China, 2010”, results obtained from the structured database (“1.3 billion”) and the unstructured database (“1.34 billion”) are pooled. If the structured database does not provide any results (for instance, because of lack of data), results from the unstructured database are taken into consideration. In an example, the aggregated results are presented to a user, for instance on a display unit.

FIG. 4 shows a flow chart of a sub-routine of the method of FIG. 3, according to an example. As mentioned earlier, a query meant for an unstructured database is processed by unstructured data processing module 108 which processes the unstructured data. Querying an unstructured database may comprise a number of stages.

At block 402, in case of a query meant for an unstructured database, primary keys are identified from the query. Primary keys are the keywords of a query. They may include names, multiword terms, abbreviations, numbers, etc. For example, if the query is “What is the population of China in 2010?”, the primary keys may be “population”, “China”, and “2010”. To provide another example, if the query is “What is the number of employees at HP?”, the primary keys may be “number”, “employees”, and “HP”. The aforementioned primary keys are merely for the purpose of illustration, and different primary keys (or different combinations of primary keys) may be identified.

At block 404, a relationship(s) between the primary keys is/are identified. A relationship signifies a plausible association between the primary keys. To provide an example, if the query is “What is the number of employees at HP?”, and the primary keys identified are “number”, employees and “HP”, then a relationship could be “number of employees” and/or “employees at HP”.

At block 406, an unstructured database(s) is/are queried based on primary keys and/or relationships identified between the primary keys. In an implementation, primary keys and/or relationships identified between the primary keys are processed by query processing module 108. Query processing module 108 processes (parses) an unstructured database based on primary keys and/or relationships identified between the primary keys. For example, query processing module 108 may apply any or all of the following modules: filter module 202, summarizer module 204, classifier module 206, feature extractor module 208, concept and relationship extractor module 210, and knowledge extractor module 212, on an unstructured database to obtain most relevant results. The aforesaid modules may be applied a sequence, such that the output from a preceding module acts as an input for the succeeding module in the series. For instance, in an implementation, the sequence may be: Filter module 202, Summarizer module 204, Classifier module 206, Feature extractor module 208, Concept and relationship extractor module 210, and Knowledge module 212. In other implementations, the order of arrangement of these modules may vary. Further, in yet another implementation, any of the aforesaid modules may be combined together, and their functions may be performed by a combined module(s).

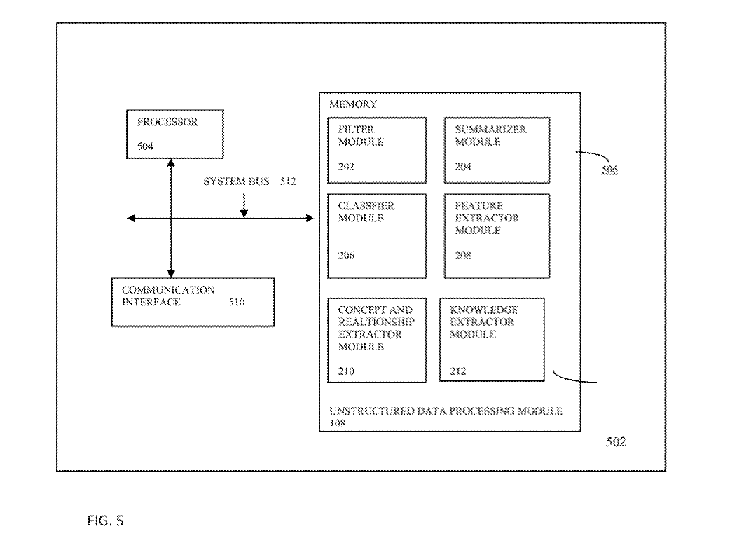

FIG. 5 is a schematic block diagram of an unstructured data processing module hosted on a computer system, according to an example.

Computer system 502 may include processor 504 memory 506, unstructured data processing module 108 and a communication interface 510. Unstructured data processing module 108 includes filter module 202, summarizer module 204, classifier module 206, feature extractor module 208, concept and relationship extractor module 210, and knowledge extractor module 212. The components of the computing system 502 may be coupled together through a system bus 512.

Processor 504 may include any type of processor, microprocessor, or processing logic that interprets and executes instructions.

Memory 506 may include a random access memory (RAM) or another type of dynamic storage device that may store information and instructions non-transitorily for execution by processor 504. For example, memory 506 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 506 may include instructions that when executed by processor 504 implement unstructured data processing module 108.

Communication interface 510 may include any transceiver-like mechanism that enables computing device 502 to communicate with other devices and/or systems via a communication link. Communication interface 510 may be a software program, a hard ware, a firmware, or any combination thereof. Communication interface 510 may use a variety of communication technologies to enable communication between computer system 502 and another computer system or device. To provide a few non-limiting examples, communication interface 510 may be an Ethernet card, a modem, an integrated services digital network (“ISDN”) card, etc.

Unstructured data processing module 108 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, unstructured data processing module 108 may be read into memory 506 from another computer-readable medium, such as data storage device, or from another device via communication interface 510.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in FIG. 5 are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of querying structured and unstructured databases, comprising;
receiving a query;
querying a structured database and an unstructured database in conjunction in response to the query, wherein querying the unstructured database comprises:
identifying primary keys from the query;
identifying relationships between the primary keys; and
querying the unstructured database based on the relationships between the primary keys.

2. The method of claim 1, further comprising:
retrieving querying results from the structured database and the unstructured database; and
aggregating the querying results retrieved from the structured database and the unstructured database.

3. The method of claim 1, further comprising:
processing unstructured data in the unstructured database based on the relationships between the primary keys, wherein the processing includes performing an action or a plurality of actions on the unstructured data.

4. The method of claim 3, wherein the action includes filtering the unstructured data.

5. The method of claim 3, wherein the action includes summarizing the unstructured data.

6. The method of claim 3, wherein the action includes classifying the unstructured data.

7. The method of claim 3, wherein the action includes performing a feature extraction on the unstructured data.

8. The method of claim 3, wherein the action includes extracting concepts and relationships from the unstructured data.

9. The method of claim 3, wherein the action includes extracting knowledge from the unstructured data.

10. A computing system, comprising:
a processor;
a non-transitory memory coupled to the processor, the memory comprising machine readable instructions that, when executed by the processor, causes the processor to:
receive a query;
query a structured database and an unstructured database in conjunction in response to the query, wherein to query the unstructured database comprises:
identifying primary keys from the query;
identifying relationships between the primary keys; and
querying the unstructured database based on the relationships between the primary keys.

11. The system of claim 10, further comprising;
aggregating query results from the structured database and the unstructured database; and
displaying the aggregated querying results.

12. The system of claim 10, further comprising:
processing unstructured data in the unstructured database based on the relationships between the primary keys, wherein the processing includes performing an action or a plurality of actions on the unstructured data.

13. The system of claim 12, wherein the plurality of actions are performed in a predefined sequence.

14. The system of claim 10, wherein the structured database and the unstructured database are independent.

15. A non-transitory processor readable medium, the non-transitory processor readable medium comprising machine executable instructions, the machine executable instructions when executed by a processor causes the processor to:
receive a query;
query a structured database and an unstructured database in conjunction in response to the query, wherein to query the unstructured database comprises:
identifying primary keys from the query;
identifying relationships between the primary keys; and
querying the unstructured database based on the relationships between the primary keys.
